(19) United States
(12) Patent Application Publication
(10) Pub. No.: US 2015/0020341 A1
(43) Pub. Date: Jan. 22, 2015

(54) Windshield Wiper Blade

(71) Applicant: Shih-Hsien Huang, Kaohsiung City (TW)

(72) Inventor: Shih-Hsien Huang, Kaohsiung City (TW)

(21) Appl. No.: 14/060,683

(22) Filed: Oct. 23, 2013

(30) Foreign Application Priority Data
Jul. 19, 2013 (CN) 201310305933.7

(51) Int. Cl. B60S 1/38

(52) U.S. Cl. CPC B60S 1/3801; B60S 2001/3815; B60S 2001/3843
USPC 15/250.452

(57) ABSTRACT

A windshield wiper blade includes a main cover having a plurality of positioning portions. A fixing seat engages with each positioning portion. Each fixing seat includes a cover pivotal portion and a frame pivotal portion. A plurality of auxiliary covers is respectively mounted to two ends of the main cover. Each auxiliary cover is pivotably connected to one of the cover pivotal portions. A frame is pivotably connected to the frame pivotal portion of each fixing seat and includes at least one claw. A soft rubber strip engages with the at least one claw of each frame.

### BACKGROUND OF THE INVENTION

1. Field of the Invention

The present invention relates to a vehicular accessory and, more particularly, to a windshield wiper blade for a vehicle.

2. Description of the Related Art

FIG. 1 shows a conventional windshield wiper blade 9 includes a main cover 91, a left cover 92, a right cover 93, a main frame 94, a left frame 95, and a right frame 96, with the main cover 91, the left cover 92, and the right cover 93 made of plastic, and with the main frame 94, the left frame 95, and the right frame 96 made of metal. The main cover 91 includes an elongated hole 911 in a center thereof, and a rod mounting seat 912 is mounted in the elongated hole 911. The left cover 92 and the right cover 93 are respectively mounted to left and right sides of the main cover 91. Each of the left and right covers 92 and 93 has a claw 921, 931. The main frame 94 also includes an elongated hole 941 in a center thereof A rod 942 is provided in the elongated hole 941. The main frame 94 is mounted in the main cover 91, with the rod 942 coupled with the rod mounting seat 912. A pair of coupling holes 943 is provided in each of left and right ends of the main frame 94 for coupling with the left and right covers 92 and 93. The left and right frames 95 and 96 are respectively riveted to the left and right ends of the main frame 94. The left frame 95 has a claw 951 on each of two ends thereof. The right frame 96 also has a claw 961 on each of two ends thereof. A rubber strip 97 extends through the claws 951 and 961 of the left and right frames 95 and 96 and through the claws 921 and 931 of the left and right covers 92 and 93. An example of the windshield wiper blade 9 is disclosed in Taiwan Utility Model No. M305148 entitled “Improved Structure of Windshield Wiper Blade”.

However, the main frame 94, the left frame 95, and the right frame 96 are made of metal materials that are heavier and more expensive than the main cover 91, the left cover 92, and the right cover 93 made of plastic. The overall weight of the windshield wiper blade 9 is increased and, thus, consumes more energy when driven. It is difficult to cut the manufacturing costs of the windshield wiper blade 9, failing to provide competitiveness in the market.

Thus, a need exists for a novel windshield wiper blade to mitigate and/or obviate the above disadvantages.

### SUMMARY OF THE INVENTION

An objective of the present invention is to provide a windshield wiper blade that has a light weight and, thus, consumes less energy during operation, providing an energy-saving effect.

Another objective of the present invention is to provide a windshield wiper blade requiring a lesser amount of metal materials for components thereof such that the windshield has a low manufacturing cost and is more competitive in the market.

The present invention fulfills the above objectives by providing a windshield wiper blade including a main cover having a plurality of positioning portions and two ends. A plurality of fixing seats respectively engages with the plurality of positioning portions. Each of the plurality of fixing seats includes a cover pivotal portion and a frame pivotal portion. A plurality of auxiliary covers is respectively mounted to the ends of the main cover. Each of the plurality of auxiliary covers is pivotably connected to one of the cover pivotal portions. Each of a plurality of frames is pivotably connected to the frame pivotal portion of one of the plurality of fixing seats and includes at least one claw. A soft rubber strip engages with the at least one claw of each of the plurality of frames.

Preferably, the main cover includes a bottom board having two sides. The main cover further includes first and second lateral boards respectively connected to the sides of the bottom board. Each of the plurality of positioning portions includes a coupling member located on the bottom board, a plurality of first abutment members located on the first and second lateral boards, and a plurality of second abutment members located on the first and second lateral boards. The coupling member is located between the plurality of first abutment members and the plurality of second abutment members.

Preferably, each of the plurality of fixing seats includes a bottom plate having two sides. Each of the plurality of fixing seats further includes first and second side plates respectively connected to the sides of the bottom plate. The bottom plate of each of the plurality of fixing seats has a coupling through-slot. Each of the first and second side plates of each of the plurality of fixing seats includes a first pressing member and a second pressing member on an edge thereof. The coupling through-slot is located between the first and second pressing members. The cover pivotal portion and the second pressing members are respectively located on two ends of the fixing seat. The coupling through-slot of each of the plurality of fixing seats is coupled with the coupling member of one of the plurality of coupling portions of the main cover. Each first pressing member of each of the plurality of fixing seats presses against and engages with one of the plurality of first abutment members of the main cover. Each second pressing member of each of the plurality of fixing seats presses against and engages with one of the plurality of second abutment members of the main cover.

Preferably, each first pressing member is a protrusion protruding outward from an outer face of the first side plate of one of the plurality of fixing seats. Each second pressing member is a protrusion protruding outward from an outer face of the second side plate of one of the plurality of fixing seats. Each first pressing member has an end face pressing against and engaged with one of the plurality of first abutment members of the main cover. Each second pressing member has an end face pressing against and engaged with one of the plurality of second abutment members of the main cover.

Preferably, each of the plurality of positioning portions of the main cover further includes a plurality of engagement members on the first and second lateral boards. Each of the plurality of engagement members is located between the coupling member and the second abutment members. Each of the plurality of fixing seats further includes a plurality of fixing lugs on the first and second side plates. Each of the plurality of fixing lugs is located between the through-slot and the second pressing members. Each of the plurality of fixing lugs engages with one of the plurality of engagement members.

Preferably, each of the plurality of fixing lugs extends outward from the edge of one of the first and second side plates and has a snapping through-hole.

Preferably, the frame pivotal portion of each of the plurality of fixing seats is located between the first pressing members and the plurality of fixing lugs of the fixing seat.

Preferably, the frame pivotal portion of each of the plurality of fixing seats is aligned with the coupling through-slot.

Preferably, each of the plurality of fixing seats further includes a plurality of abutment elements located on the bottom board of the main cover and located on two sides of the coupling member. The bottom plate of each of the plurality of fixing seats has an outer face abutting the plurality of abutment elements.

Preferably, the coupling member has an edge connected to the bottom board and the first and second lateral boards of the main cover.

Preferably, the coupling through-slot of each of the plurality of fixing seats has two ends respectively extending to the first and second side plates of the fixing seat.

The manufacturing costs of the windshield wiper blade according to the present invention can be cut by reducing the number of metal components, reducing the energy required for driving the windshield wiper blade. Thus, the windshield wiper blade according to the present invention saves energy and provides increased competitiveness in the market.

The present invention will become clearer in light of the following detailed description of illustrative embodiments of this invention described in connection with the drawings.

### BRIEF DESCRIPTION OF THE DRAWINGS

FIG. 1 is an exploded, perspective view of a conventional windshield wiper blade.

FIG. 2 is an exploded, perspective view of a windshield wiper blade according to the present invention.

FIG. 3 is a partial, exploded, perspective view of a portion of the windshield wiper blade of FIG. 2.

FIG. 4 is a perspective view of the portion of the windshield wiper blade of FIG. 3.

FIG. 5 is a cross sectional view taken along section line 5-5 of FIG. 4.

FIG. 6 is a cross sectional view taken along section lien 6-6 of FIG. 5.

FIG. 7 is a cross sectional view taken along section lien 7-7 of FIG. 5.

### DETAILED DESCRIPTION OF THE INVENTION

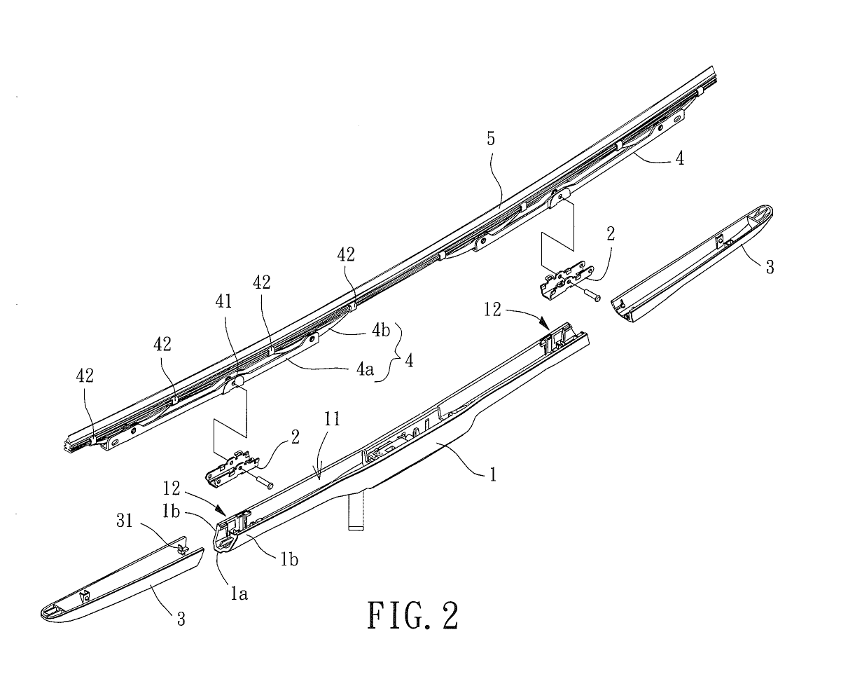

With reference to FIG. 2, a windshield wiper blade according to the present invention includes a main cover 1, a plurality of fixing seats 2, a plurality of auxiliary covers 3, a plurality of frames 4, and a soft rubber strip 5. The fixing seats 2 engage with the main cover 1. The auxiliary covers 3 are respectively mounted to two ends of the main cover 1 and pivotably connected to the fixing seats 2. The frames 4 are also pivotably connected to the fixing seats 2. The main cover 1 and the auxiliary covers 3 enclose and protect the frames 4. The soft rubber strip 5 is coupled to the frames 4. A windshield wiper blade is, thus, formed.

Specifically, the main cover 1 includes a bottom board 1 a and first and second lateral boards 1b respectively connected to two sides of the bottom board 1a, forming an elongated housing having substantially U-shaped cross sections and defining an open compartment 11. The main cover 1 further includes a plurality of positioning portions 12 for respectively coupling and positioning the fixing seats 2. In this embodiment, the main cover 1 includes two positioning portions 12 adjacent to the ends of the main cover 1 which are spaced from each other in a longitudinal direction of the main cover 1. After engagement, each fixing seat 2 partially protrudes outside of one of the ends of the main cover 1, and each auxiliary cover 3 is pivotably connected to the protruded portion of one of the fixing seats 2.

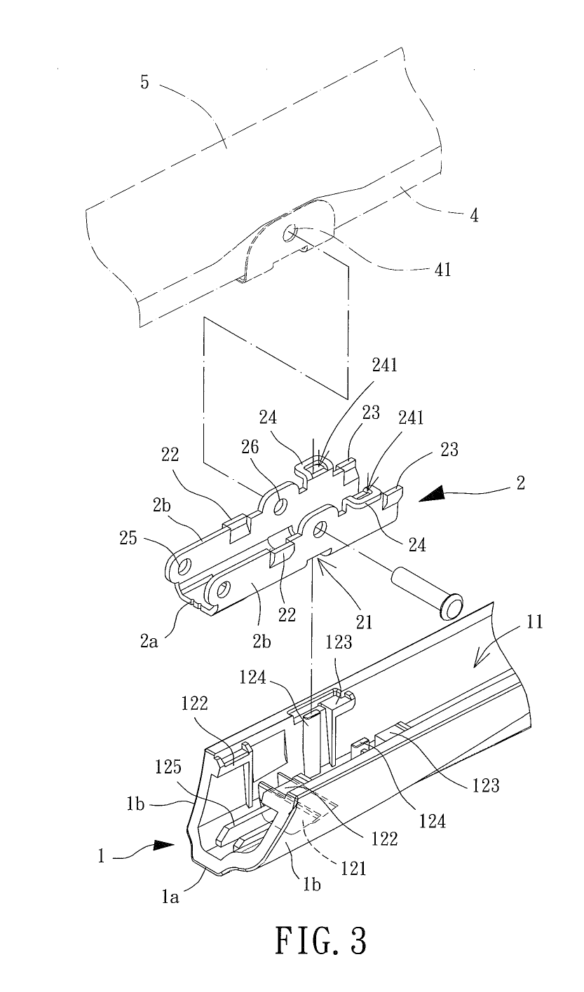

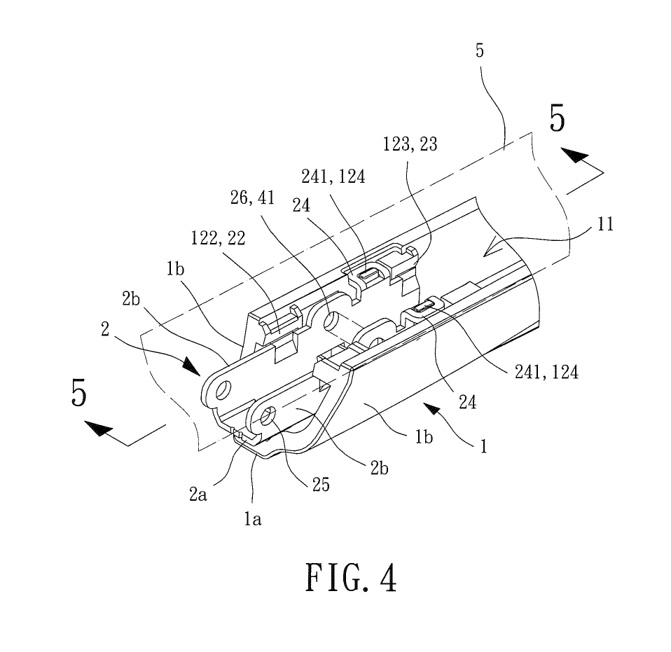

With reference to FIGS. 3 and 4, in this embodiment, each positioning portion 12 includes a coupling member 121, a plurality of first abutment members 122, a plurality of second abutment members 123, and a plurality of engagement members 124, such that each fixing seat 2 can reliably engage with the main cover 1, avoiding movement of the fixing seats 2 relative to the main cover 1 in any direction. Specifically, the coupling member 121 is located on the bottom board 1a. When each fixing seat 2 is inserted into an interior of the main cover 1 to a predetermined depth, each fixing seat 2 engages with and positioned by the coupling member 121 of a corresponding positioning portion 12. Preferably, the coupling member 121 of each positioning portion 12 has an edge connected to the bottom board 1a and the first and second lateral boards 1b of the main cover 1. This allows easy manufacture and easy formation of the coupling member 121, and the coupling member 121 can be used as a reinforcing structure between the bottom board 1a and the lateral boards 1b. Thus, the main cover 1 is less likely to deform when subjected to an external force.

The first abutment members 122 of each positioning portion 12 are respectively located on the first and second lateral boards 1b. Also, the second abutment members 123 and the engagement members 124 of each positioning portion 12 are located on the first and second lateral boards 1b. The coupling member 121 is located between the first abutment members 122 and the second abutment members 123. Each engagement member 124 is located between the coupling member 121 and the second abutment members 123. Each positioning portion 12 further includes a plurality of abutment elements 125 located on the bottom board 1a of the main cover 1 and located on two sides of the coupling member 121. The outer face of each fixing seat 2 abuts the abutment elements 125.

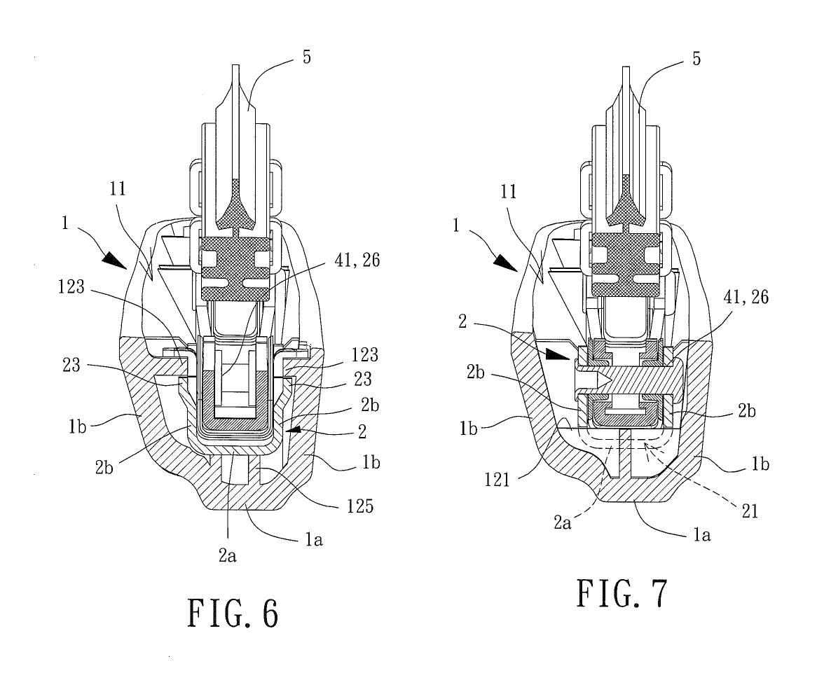

The fixing seats 2 respectively engage with the positioning portions 12 of the main cover 1. Each fixing seat 2 includes a bottom plate 2a and first and second side plates 2b respectively connected to two sides of the bottom plate 2a, forming a base having substantially U-shaped cross sections. A spacing between the side plates 2b of each fixing seat 2 is smaller than a spacing between the lateral boards 1b of the main cover 1 such that each fixing seat 2 can be received in the compartment 11 of the main cover 1. In this embodiment, the bottom plate 2a of each fixing seat 2 has a coupling through-slot 21. When each fixing seat 2 is placed into the compartment 11 of the main cover 1, the coupling through-slot 21 engages with the coupling member 121 of a corresponding positioning portion 12 (FIG. 6), and the abutment elements 125 of each positioning portion 12 abut an outer face at two sides of the coupling through-slot 21 of the bottom board 2a (FIG. 7). Thus, each fixing seat 2 is reliably positioned and can not turn. Furthermore, two ends of the coupling slot 21 preferably extend to the first and second side plates 2b of the fixing seat 2, respectively, increasing the coupling area between the coupling member 121 and the coupling through-slot 21 to enhance the engagement reliability therebetween.

Furthermore, to provide reliable engagement with the positioning portions 12 of the main cover 1, each of the first and second side plates 2b of each fixing seat 2 includes a first pressing member 22, a second pressing member 23, and a fixing lug 24 on an edge thereof. The coupling through-slot 21 is located between the first and second pressing members 22 and 23. Each fixing lug 24 is located between the through-slot 21 and the second pressing members 23. Each first pressing member 22 is a protrusion protruding outward from an outer face of the first side plate 2b of one of the fixing seats 2. Each second pressing member 23 is a protrusion protruding outward from an outer face of the second side plate 2b of one of the fixing seats 2. Each fixing lug 24 extends outward from the edge of one of the first and second side plates 2b and has a snapping through-hole 241.

When each fixing seat 2 is placed into the compartment 11 of the main cover 1, an end face of each first pressing member 22 of each fixing seat 2 presses against and engages with one of the first abutment members 122 of the main cover 1, and an end face of each second pressing member 23 of each fixing seat 2 presses against and engages with one of the second abutment members 123 of the main cover 1. At the same time, each lug 24 is coupled with a corresponding engagement member 124 of the main cover 1 (FIG. 7). Thus, each fixing seat 2 is reliably fixed to a predetermined location (i.e., the corresponding positioning portion 12) of the main cover 1, avoiding rotation or movement of each fixing seat 2 relative to the main cover 1 in any direction.

Furthermore, each fixing seat 2 includes a cover pivotal portion 25 and a frame pivotal portion 26, wherein the cover pivotal portion 25 and the second pressing members 23 are respectively on two ends of the fixing seat 2. The cover pivotal portion 25 of each fixing seat 2 is pivotably connected to one of the auxiliary covers 3. The frame pivotal portion 26 of each fixing seat 2 is located between the first pressing members 22 and the fixing lugs 24 and is pivotably connected to one of the frames 4. Preferably, the frame pivotal portion 26 of each fixing seat 2 is aligned with the coupling through-slot 21 of the fixing seat 2, such that the pivotal axes of the frame 4 and the fixing seat 2 are aligned with each other. Further, by providing reliable engagement of the fixing seats 2 in the main cover 1, the fixing seats 2 are less likely to pivot or move while the frames 4 are subjected to force. Thus, the structure of the windshield wiper blade is sturdier, is less likely to damage, and is less likely to generate noise resulting from impact between the components during operation.

With reference to FIGS. 2 and 3, each auxiliary cover 3 has a pivotal portion 31 adjacent to an end thereof. In this embodiment, two auxiliary covers 3 are provided. The pivotal portion 31 of each auxiliary cover 3 is pivotably connected to the cover pivotal portion 25 of a corresponding fixing seat 2. Thus, the auxiliary covers 3 are mounted to the ends of the main cover 1 and cooperate with the main cover 1 to protect the components received in the main cover 1.

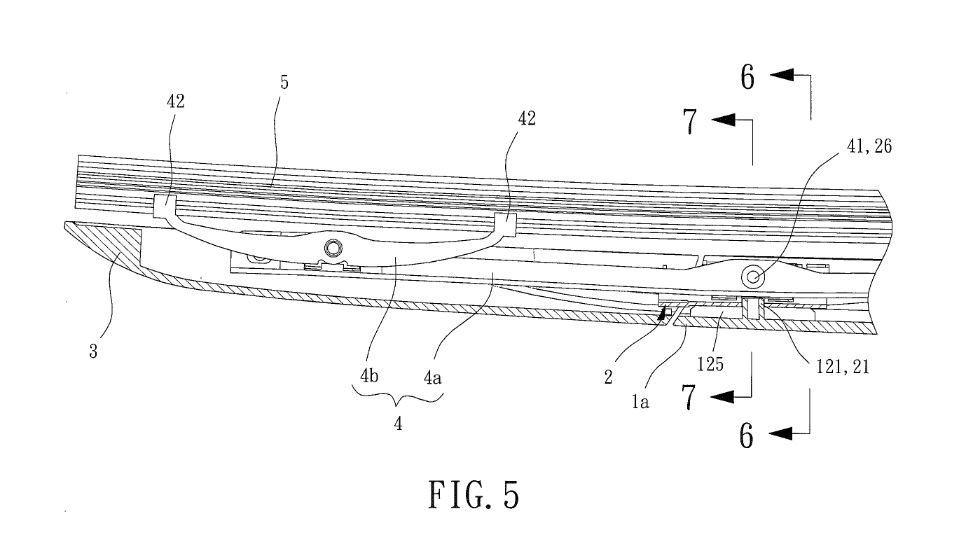

With reference to FIGS. 2 and 5, each frame 4 includes a pivotal portion 41 pivotably connected to the frame pivotal portion 26 of a corresponding fixing seat 2 and includes at least one claw 42. The soft rubber strip 5 extends through and engages with the at least one claw 42 of each of frame 4. In this embodiment, each frame 4 includes a main frame 4a and two sub frames 4b. The pivotal portion 41 is located in a center of the main frame 4a. The sub frames 4b are pivotably connected to the main frame 4a at locations adjacent to two ends of the main frame 4a, respectively. Each sub frame 4b includes two ends each having a claw 42. Thus, each frame 4 has four claws 42.

In another embodiment, each frame 4 includes a main frame 4a and a sub frame 4b. The pivotal portion 41 is located in a center of the main frame 4a. The sub frame 4b is pivotably connected to the main frame 4a at a location adjacent to one of two ends of the main frame 4a. The sub frame 4b includes two ends each having a claw 42. The other end of the main frame 4a not pivotably connected to the sub frame 4b includes a claw 42. Thus, each frame 4 has three claws 42. Alternatively, each frame 4 does not have to include the sub frame 4b, and a claw 42 is provided on each of two ends of the main frame 4a such that each frame 4 has two claws 42. Namely, the number and type of the claws 42 of the frames 4 can be adjusted according to needs.

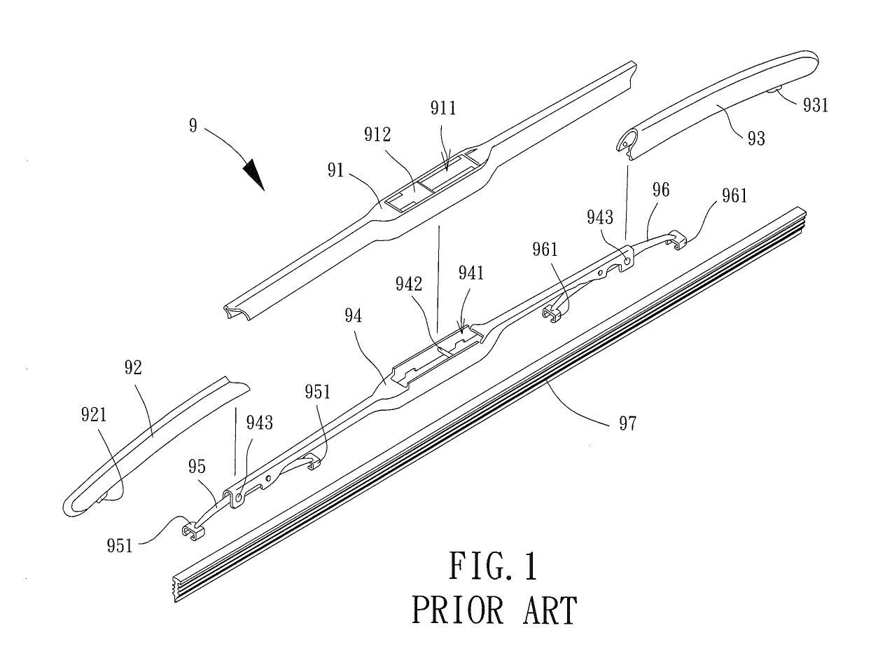

Based on the above structure, the windshield wiper blade includes a plurality of fixing seats 2 mounted in the main cover 1 for pivotal connection with the auxiliary covers 3 and the frames 4, and the soft rubber strip 5 is mounted to the frames 4, forming the windshield wiper blade. With reference to FIGS. 1 and 2, compared to the conventional windshield wiper blade 9 requiring the main frame 94 mounted in the main cover 91 for coupling with the left and right covers 92 and 93 and for pivotal connection with the left and right frames 95 and 96, the windshield wiper blade according to the present invention only uses a plurality of small fixing seats 2 to replace the main cover 91, significantly reduce the overall weight of the windshield wiper blade while saving the metal materials. Thus, the manufacturing costs of the windshield wiper blade are significantly reduced.

In view of the foregoing, the windshield wiper blade according to the present invention uses a plurality of small fixing seats 2 reliably engaged in the main cover 1 for pivotal connection with the auxiliary covers 3 and the frames 4 such that the overall weight of the windshield wiper blade according to the present invention is small and, thus, consumes less energy when driven, achieve the energy saving effect.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A windshield wiper blade comprising:
a main cover including a plurality of positioning portions and two ends;
a plurality of fixing seats respectively engaged with the plurality of positioning portions, with each of the plurality of fixing seats including a cover pivotal portion and a frame pivotal portion;
a plurality of auxiliary covers respectively mounted to the two ends of the main cover, with each of the plurality of auxiliary covers pivotably connected to one of the cover pivotal portions;
a plurality of frames, with each of the plurality of frames pivotably connected to the frame pivotal portion of one of the plurality of fixing seats, with each of the plurality of frames including at least one claw; and
a soft rubber strip engaged with the at least one claw of each of the plurality of frames.

2. The windshield wiper blade as claimed in claim 1, with the main cover including a bottom board having two sides, with the main cover further including first and second lateral boards respectively connected to the two sides of the bottom board, with each of the plurality of positioning portions including a coupling member located on the bottom board, a plurality of first abutment members located on the first and second lateral boards, and a plurality of second abutment members located on the first and second lateral boards, with the coupling member located between the plurality of first abutment members and the plurality of second abutment members.

3. The windshield wiper blade as claimed in claim 2, with each of the plurality of fixing seats including a bottom plate having two sides, with each of the plurality of fixing seats further including first and second side plates respectively connected to the two sides of the bottom plate, with the bottom plate of each of the plurality of fixing seats having a coupling through-slot, with each of the first and second side plates of each of the plurality of fixing seats including a first pressing member and a second pressing member on an edge thereof, with the coupling through-slot located between the first and second pressing members, with the cover pivotal portion and the second pressing members respectively located on two ends of the fixing seat, with the coupling through-slot of each of the plurality of fixing seats coupled with the coupling member of one of the plurality of coupling portions of the main cover, with each first pressing member of each of the plurality of fixing seats pressing against and engaged with one of the plurality of first abutment members of the main cover, with each second pressing member of each of the plurality of fixing seats pressing against and engaged with one of the plurality of second abutment members of the main cover.

4. The windshield wiper blade as claimed in claim 3, with each first pressing member being a protrusion protruding outward from an outer face of the first side plate of one of the plurality of fixing seats, with each second pressing member being a protrusion protruding outward from an outer face of the second side plate of one of the plurality of fixing seats, with each first pressing member having an end face pressing against and engaged with one of the plurality of first abutment members of the main cover, with each second pressing member having an end face pressing against and engaged with one of the plurality of second abutment members of the main cover.

5. The windshield wiper blade as claimed in claim 3, with each of the plurality of positioning portions of the main cover further including a plurality of engagement members on the first and second lateral boards, with each of the plurality of engagement members located between the coupling member and the second abutment members, with each of the plurality of fixing seats further including a plurality of fixing lugs on the first and second side plates, with each of the plurality of fixing lugs located between the through-slot and the second pressing members, with each of the plurality of fixing lugs engaged with one of the plurality of engagement members.

6. The windshield wiper blade as claimed in claim 5, with each of the plurality of fixing lugs extending outward from the edge of one of the first and second side plates and having a snapping through-hole.

7. The windshield wiper blade as claimed in claim 5, with the frame pivotal portion of each of the plurality of fixing seats located between the first pressing members and the plurality of fixing lugs of the fixing seat.

8. The windshield wiper blade as claimed in claim 7, with the frame pivotal portion of each of the plurality of fixing seats aligned with the coupling through-slot.

9. The windshield wiper blade as claimed in claim 3, with each of the plurality of fixing seats further including a plurality of abutment elements located on the bottom board of the main cover and located on two sides of the coupling member, with the bottom plate of each of the plurality of fixing seats having an outer face abutting the plurality of abutment elements.

10. The windshield wiper blade as claimed in claim 9, with the coupling member having an edge connected to the bottom board and the first and second lateral boards of the main cover.

11. The windshield wiper blade as claimed in claim 3, with the coupling through-slot of each of the plurality of fixing seats having two ends respectively extending to the first and second side plates of the fixing seat.
